(19) United States
(12) Patent Application Publication
(10) Pub. No.: US 2025/0162332 A1
(43) Pub. Date: May 22, 2025

(54) PRINTING APPARATUS

(71) Applicant: SEIKO EPSON CORPORATION, Tokyo (JP)

(72) Inventors: Yuichi WASHIO, SHIOJIRI-SHI (JP); Satoru KATAGAMI, HARA-MURA (JP); Ko TAKANASHI, MATSUMOTO-SHI (JP); Kazutoshi FUJISAWA, OKAYA-SHI (JP)

(21) Appl. No.: 18/950,303

(22) Filed: Nov. 18, 2024

(30) Foreign Application Priority Data
Nov. 21, 2023 (JP) 2023-197186

(51) Int. Cl. B41J 11/00

(52) U.S. Cl. CPC B41J 11/00222; B41J 11/00242

(57) ABSTRACT

A printing apparatus includes a transport unit, a printing unit, a drying unit, and a control unit. The drying unit includes a contact heating unit with a contact heating surface configured to contact a back surface of a medium and an airflow ejecting unit with an airflow ejecting port. The control unit performs first control and second control. In the first control, the airflow ejecting unit is controlled such that an airflow is a first velocity. In the second control, an airflow velocity is slower than the first velocity. While the printing apparatus being in operation, the control unit performs the first control when a stopping period is less than a predetermined period, and performs the second control when the stopping period is equal to or more than the predetermined period, the stopping period being a period in which transporting the medium is at rest.

The present application is based on, and claims priority from JP Application Serial Number 2023-197186, filed on Nov. 21, 2023, the disclosure of which is hereby incorporated by reference herein in its entirety.

### BACKGROUND

### 1. Technical Field

The present disclosure relates to a printing apparatus.

### 2. Related Art

Various types of printing apparatuses have been used. Of these printing apparatuses, there is a printing apparatus provided with a drying unit used to dry a liquid discharged onto a medium. The drying unit includes an airflow ejecting unit configured to blow an airflow onto a printing surface of the medium, and also includes a contact heating surface configured to bring a heating unit into contact with a back surface of the medium that is opposite from the printing surface and at a position that is opposed to the airflow ejecting unit. For example, JP-A-2023-133808 discloses a printing apparatus including, within a drying unit, a first heater and a second heater configured to come into contact with the back surface of a medium to heat the medium, and also including a first non-contact heating unit and a second non-contact heating unit disposed so as to be opposed to the first heater and the second heater and configured to deliver heated airflow onto the front surface of the medium.

In a case of the printing apparatus including the airflow ejecting unit and the contact heating surface provided at a position that is opposed to the airflow ejecting unit, the airflow ejected from the airflow ejecting unit presses the medium against the contact heating surface. Thus, depending on types of the medium that is used or the like, there is a possibility that the back surface of the medium and the contact heating surface stick to each other, or a frictional force occurring at the time of transporting the medium increases to reduce the transport performance.

### SUMMARY

A printing apparatus according to the present disclosure used to solve the problem described above includes a transport unit configured to transport a medium in a transport direction, a printing unit configured to discharge a liquid to the medium transported by the transport unit to perform printing, a drying unit configured to dry the medium having a printing surface on which printing is performed by the printing unit, and a control unit, in which the drying unit includes a contact heating unit and an airflow ejecting unit disposed at a position that is opposed to the contact heating unit, the airflow ejecting unit being configured to eject an airflow from an airflow ejecting port, the contact heating unit includes a contact heating surface configured to come into contact with a back surface that is a surface opposite from the printing surface, the airflow ejecting port is opposed to the contact heating surface, the control unit is configured to perform first control and second control, the first control is control in which the airflow ejecting unit is controlled such that a reaching velocity is a first velocity, the reaching velocity being a velocity when an airflow ejected from the airflow ejecting unit reaches the printing surface of the medium supported by the contact heating surface, the second control is control in which the airflow ejecting unit is controlled such that the reaching velocity is slower than the first velocity, and while the printing apparatus is in operation, the control unit is configured to perform the first control when a stopping period is less than a predetermined period, and perform the second control instead of the first control when the stopping period is equal to or more than the predetermined period, the stopping period being a period in which transport of the medium by the transport unit is at rest.

### BRIEF DESCRIPTION OF THE DRAWINGS

FIG. 1 is a side view illustrating a printing apparatus according to a first embodiment of the present disclosure.

FIG. 2 is a side view illustrating a drying unit of the printing apparatus in FIG. 1 and its surroundings.

FIG. 3 is a plan view illustrating a first contact heating surface at the drying unit of the printing apparatus in FIG. 1 and its surroundings.

FIG. 4 is a cross-sectional view illustrating the drying unit of the printing apparatus in FIG. 1 and its surroundings as viewed from the back surface side.

FIG. 5 is a perspective view illustrating the drying unit of the printing apparatus in FIG. 1 and its surroundings.

FIG. 6 is a perspective view illustrating the drying unit of the printing apparatus in FIG. 1 and its surroundings as viewed from an angle differing from FIG. 5.

FIG. 7 is a diagram used to describe an example of controlling of an airflow by a control unit.

FIG. 8 is a schematic side view used to describe a method of adjusting a first gap in the printing apparatus in FIG. 1.

FIG. 9 is a schematic view illustrating a positional relationship between a cam and a cam follower of a distance changing unit of the drying unit of the printing apparatus in FIG. 8.

FIG. 10 is a schematic back view illustrating the distance changing unit of the drying unit of the printing apparatus in FIG. 8 and its surroundings.

### DESCRIPTION OF EMBODIMENTS

First, the present disclosure will be schematically described.

A printing apparatus according to a first aspect of the present disclosure used to solve the problem described above includes: a transport unit configured to transport a medium in a transport direction; a printing unit configured to discharge a liquid to the medium transported by the transport unit to perform printing; a drying unit configured to dry the medium having a printing surface on which printing is performed by the printing unit; and a control unit, in which the drying unit includes a contact heating unit and an airflow ejecting unit disposed at a position that is opposed to the contact heating unit, the airflow ejecting unit being configured to eject an airflow from an airflow ejecting port, the contact heating unit includes a contact heating surface configured to come into contact with a back surface that is a surface opposite from the printing surface, the airflow ejecting port is opposed to the contact heating surface, the control unit is configured to perform first control and second control, the first control is control in which the airflow ejecting unit is controlled such that a reaching velocity is a first velocity, the reaching velocity being a velocity when an airflow ejected from the airflow ejecting unit reaches the printing surface of the medium supported by the contact heating surface, the second control is control in which the airflow ejecting unit is controlled such that the reaching velocity is slower than the first velocity, and while the printing apparatus is in operation, the control unit is configured to perform the first control when a stopping period is less than a predetermined period, and perform the second control instead of the first control when the stopping period is equal to or more than the predetermined period, the stopping period being a period in which transport of the medium by the transport unit is at rest.

With the present aspect, it is possible to perform the first control in which the reaching velocity of an airflow to the printing surface is the first velocity and the second control in which the reaching velocity of the airflow to the printing surface is slower than the first velocity. In addition, while the printing apparatus is in operation, it is possible to perform the first control when the stopping period is less than a predetermined period, and perform the second control instead of the first control when the stopping period is equal to or more than the predetermined period. When the stopping period is equal to or more than a predetermined period, there is a possibility that the back surface of the medium and the contact heating surface stick to each other or a frictional force occurring during transporting the medium increases, which deteriorates the transport performance. In such a case, the present aspect makes it possible to reduce the reaching velocity of the airflow to the printing surface. Thus, it is possible to suppress sticking of the back surface of the medium and the contact heating surface to each other and suppress an increase in the frictional force.

A printing apparatus of a second aspect of the present disclosure provides an aspect according to the first aspect, in which the control unit is configured to determine, according to a material of the back surface, whether to perform the first control or the second control when the stopping period is equal to or more than the predetermined period.

Depending on a material of the back surface of a medium, it is more likely that the back surface of the medium and the contact heating surface stick to each other or a frictional force occurring during transporting the medium increases, which deteriorates the transport performance. However, the present aspect is configured to determine, according to the material of the back surface of the medium, whether to perform the first control or the second control when the stopping period is equal to or more than the predetermined period. Thus, it is possible to suppress sticking of the back surface of the medium and the contact heating surface to each other and suppress an increase in the frictional force regardless of the material of the back surface of the medium.

A printing apparatus of a third aspect of the present disclosure provides an aspect according to the second aspect, in which the control unit is configured to perform the second control when the back surface includes polyethylene as a material.

When the back surface of a medium includes polyethylene as a material, it is more likely that the back surface of the medium and the contact heating surface stick to each other or a frictional force occurring at the time of transporting the medium increases, which deteriorates the transport performance. However, the present aspect is configured such that the second control is performed when the material of the back surface includes polyethylene. Thus, even when the back surface of a medium includes polyethylene as a material, it is possible to suppress sticking of the back surface of the medium and the contact heating surface to each other and suppress an increase in the frictional force.

A printing apparatus of a fourth aspect of the present disclosure provides an aspect according to any one of the first to third aspects, in which the control unit is configured, as the second control, to control the airflow ejecting unit such that the reaching velocity is a second velocity slower than the first velocity and also control the airflow ejecting unit such that the reaching velocity is a third velocity faster than the second velocity and slower than first velocity.

The present aspect is configured, as the second control, to control the airflow ejecting unit such that the reaching velocity of the airflow to the printing surface is the second velocity slower than the first velocity, and also control the airflow ejecting unit such that the reaching velocity of the airflow to the printing surface is the third velocity faster than the second velocity and slower than first velocity. Thus, it is possible to change the reaching velocity of the airflow to the printing surface in at least three or more stages. This makes it possible to favorably suppress sticking of the back surface of the medium and the contact heating surface to each other and suppress an increase in the frictional force.

A printing apparatus of a fifth aspect of the present disclosure provides an aspect according to the fourth aspect, in which the control unit is configured, as the second control, to control the airflow ejecting unit to achieve the second velocity and then control the airflow ejecting unit to achieve the third velocity, and as the first control, to further control the airflow ejecting unit to achieve the first velocity.

The present aspect is configured to control the airflow ejecting unit to achieve the second velocity and then control the airflow ejecting unit to achieve the third velocity, and to further control the airflow ejecting unit to achieve the first velocity. By performing control in this manner, it is possible to particularly favorably suppress sticking of the back surface of the medium and the contact heating surface to each other and suppress an increase in the frictional force.

A printing apparatus of a sixth aspect of the present disclosure provides an aspect according to any one of the first to third aspects, in which the transport unit intermittently transports the medium during performing printing on the medium by the printing unit, the printing unit discharges the liquid to the medium when transporting is at rest during the intermittent transporting, and does not discharge the liquid to the medium when transporting is performed during the intermittent transporting, and the control unit is configured to control the airflow ejecting unit such that the reaching velocity is slower than the first velocity when the medium is transported during the intermittent transporting.

The present aspect is configured such that the airflow ejecting unit is controlled such that the reaching velocity of the airflow to the printing surface is slower than the first velocity when the medium is transported during the intermittent transporting. When the airflow at the time of transporting the medium during the intermittent transporting is strong, and the medium is pressed against the contact heating surface, a frictional force is more likely to increase. However, the present aspect is able to suppress such an increase in the frictional force.

A printing apparatus of a seventh aspect of the present disclosure provides an aspect according to any one of the first to third aspects, in which the control unit is configured to control an air volume of the airflow ejecting unit to control the reaching velocity.

The present aspect is configured to control the air volume of the airflow ejecting unit to control the reaching velocity of the airflow to the printing surface. By employing such a configuration, it is possible to favorably control the reaching velocity of the airflow to the printing surface without increasing the number of component members.

A printing apparatus of an eighth aspect of the present disclosure provides an aspect according to any one of the first to third aspects, in which the airflow ejecting unit includes: a fan configured to generate the airflow; and an air guiding section configured to couple the fan and the airflow ejecting port; and a valve provided at the air guiding section and configured to control a degree of closing or opening, in which the control unit is configured to control the degree of closing or opening of the valve to control the reaching velocity.

The present aspect is configured to control the degree of closing or opening of the valve to control the reaching velocity of the airflow to the printing surface. Thus, by controlling the degree of closing or opening of the valve, it is possible to favorably control the reaching velocity of the airflow to the printing surface.

A printing apparatus of a ninth aspect of the present disclosure provides an aspect according to any one of the first to third aspects, in which the airflow ejecting unit includes a distance changing unit configured to change a distance between the contact heating surface and the airflow ejecting port, and the control unit is configured to control the distance changing unit to change the distance, thereby controlling the reaching velocity.

The present aspect is configured to change the distance between the contact heating surface and the airflow ejecting port, thereby controlling the reaching velocity of the airflow to the printing surface. Thus, by changing the distance between the contact heating surface and the airflow ejecting port, it is possible to favorably control the reaching velocity of the airflow to the printing surface.

A printing apparatus of a tenth aspect of the present disclosure provides an aspect according to any one of the first to third aspects, in which the control unit is configured to select at least one of: causing a temperature of the contact heating surface during the second control to be higher than a temperature during the first control; increasing a temperature of the airflow ejected from the airflow ejecting port; and increasing a period of time in which the medium stays within the drying unit.

The present aspect is configured to select at least one of: causing a temperature of the contact heating surface during the second control to be higher than a temperature during the first control; increasing a temperature of the airflow ejected from the airflow ejecting port; and increasing a period of time in which the medium stays within the drying unit. As the reaching velocity of the airflow to the printing surface is reduced, the drying efficiency reduces as compared with the first control being performed. However, such a configuration makes it possible to achieve drying aid for this reduction in the drying efficiency, by selecting at least one of: increasing a temperature of the contact heating surface; increasing a temperature of the airflow ejected from the airflow ejecting port; and increasing a period of time in which the medium stays within the drying unit.

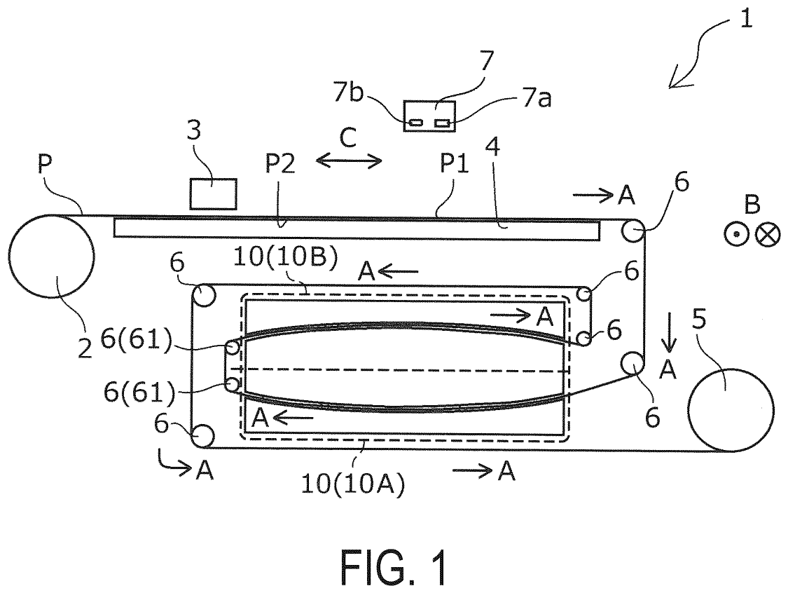

Below, embodiment according to the present disclosure will be specifically described with reference to the drawings. First, a printing apparatus 1 according to one embodiment of the present disclosure will be schematically described with reference to FIG. 1. As illustrated in FIG. 1, the printing apparatus 1 according to the present embodiment includes: a set unit 2 at which a medium P in a roll form is set; a winding unit 5 configured to wind the medium P transported from the set unit 2; a printing head 3 serving as a printing unit configured to discharge liquid ink on a printing surface P1 of the medium P transported in a transport direction A in a transport path from the set unit 2 to the winding unit 5, to form an image. In addition, the printing apparatus 1 includes a platen 4 configured to support the medium P in an image formation region where the image is formed by the printing head 3, and a plurality of rollers 6 provided in the transport path of the medium P. The printing apparatus 1 according to the present embodiment includes, as the rollers 6, a driving roller serving as a transport unit and configured to apply transport force to the medium P, and also includes a driven roller that rotates in a following manner in association with transport of the medium P. Furthermore, the printing apparatus 1 according to the present embodiment includes a control unit 7 including a CPU 7a, a storage unit 7b, and the like, and each component member of the printing apparatus 1 according to the present embodiment is driven by control performed by the control unit 7. The control unit 7 is able to input information or the like regarding the medium P to be used, from an external compute or the like coupled to the printing apparatus 1 according to the present embodiment.

The printing head 3 is provided at a side of the medium P transported in the transport direction A, this side being opposed to the printing surface P1. The printing head 3 discharges ink on the printing surface P1 in a state where a back surface P2 of the medium P that is opposite from the printing surface P1 is supported by the platen 4, thereby forming an image. Specifically, the printing apparatus 1 according to the present embodiment performs printing by causing the printing head 3 to reciprocate in a scanning direction C along the transport direction A. More specifically, the printing apparatus 1 according to the present embodiment causes the printing head 3 to reciprocate in the scanning direction C while intermittently driving (intermittently transporting) the medium P in the transport direction A, and causes ink to be discharged from the printing head 3, thereby performing printing.

The printing head 3 according to the present embodiment can complete the image formation of the entire image formation region of the printing surface P1 that is supported by the platen 4 through a single scan (single pass), and also can complete the image formation of the entire image formation region by performing scanning a plurality of times (a plurality of passes). When the image formation is completed by a plurality of passes, the transport stopping period of the printing medium P due to the intermittent transport is naturally longer than when the image formation is completed by a single pass.

The printing head 3 according to the present embodiment is configured to reciprocate in the scanning direction C along the transport direction A to perform printing. However, there is no particular limitation as to the configuration of the printing head 3. Instead of the printing head 3 configured to reciprocate in the scanning direction C along the transport direction A to perform printing, there may be provided a printing head 3 configured to reciprocate in a width direction B intersecting the transport direction A to perform printing, or there may be provided a so-called a line head in which nozzles configured to discharge ink over the entire width direction B of the medium P are arranged along the width direction B and printing is performed in a state where the printing head is at rest.

As illustrated in FIG. 1, a drying unit 10 configured to dry ink discharged on the medium P is provided downstream, in the transport direction A, of the printing head 3 in the transport path of the medium P. A plurality of driven rollers 6 are provided in a transport path of the medium P from the printing head 3 to the drying unit 10 as well as in a transport path of the medium P from the drying unit 10 to the winding unit 5. The printing apparatus 1 according to the present embodiment includes, as the drying unit 10, a first drying unit 10A where the medium P first reaches from the printing head 3, and also includes a second drying unit 10B configured to further dry the medium P after the medium P is dried at the first drying unit 10A. As illustrated in FIG. 1, in the present embodiment, the first drying unit 10A and the second drying unit 10B are provided at the upper and lower sides. However, the configuration is not limited to such a configuration.

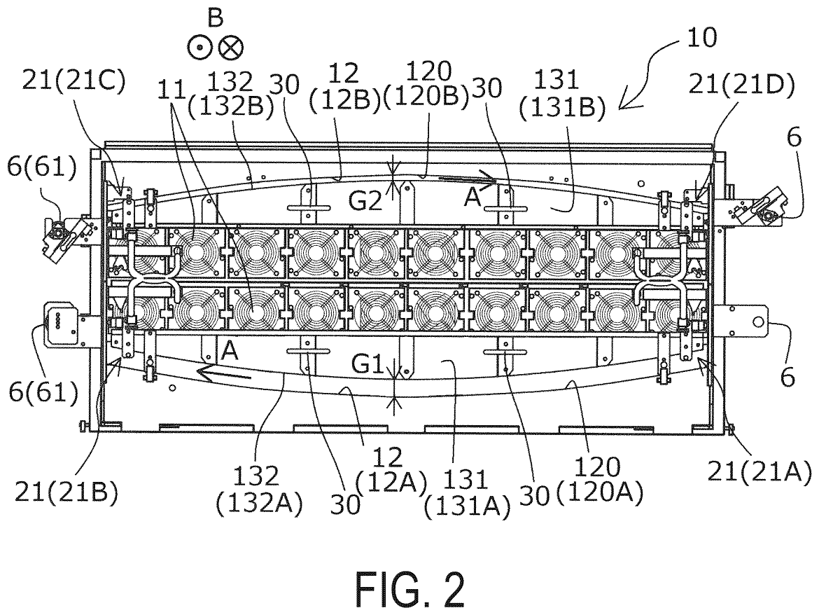

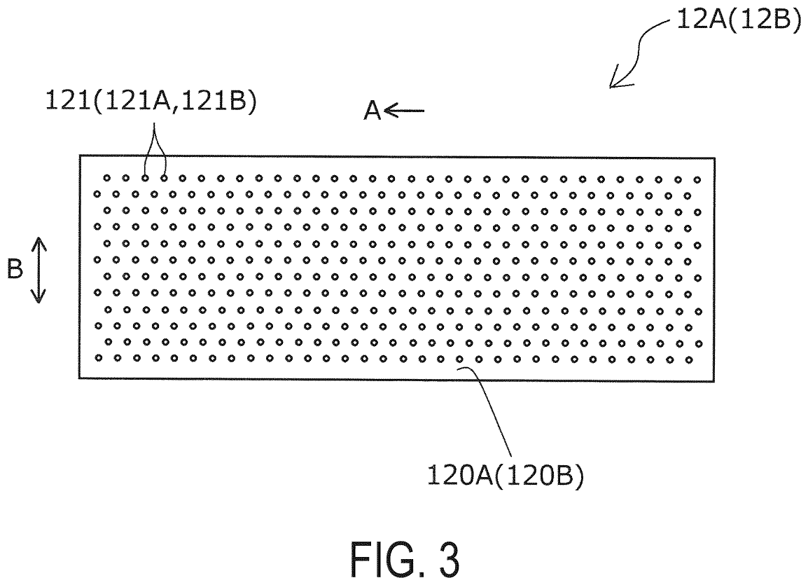

Below, the drying unit 10 will be described more in detail with reference to FIGS. 2 and 3. As illustrated in FIG. 2, the drying unit 10 includes a plurality of fans 11. As described above, the drying unit 10 is separated into the first drying unit 10A and the second drying unit 10B. The first drying unit 10A is able to eject an airflow generated at the fans 11, from a first airflow ejecting unit 12A at the lower face side toward the printing surface P1 of the medium P. The second drying unit 10B is able to eject an airflow generated at the fans 11, from a second airflow ejecting unit 12B at the upper face side toward the printing surface P1 of the medium P. The first airflow ejecting unit 12A and the second airflow ejecting unit 12B have a similar configuration, and the first airflow ejecting unit 12A is illustrated in FIG. 3.

In the first airflow ejecting unit 12A, a plurality of airflow ejecting ports 121 (first airflow ejecting ports 121A) are arrayed in a staggered manner in the width direction B and the transport direction A, as illustrated in FIG. 3. Since the first airflow ejecting unit 12A and the second airflow ejecting unit 12B as the airflow ejecting unit 12 have a similar configuration as described above, it is possible to read the first airflow ejecting unit 12A as the second airflow ejecting unit 12B, and also read the first airflow ejecting port 121A as the second airflow ejecting port 121B. The first drying unit 10A includes a first contact heating unit 131A serving as a contact heating unit 131 and provided in a region of the transport path of the medium P that is opposed to the first airflow ejecting unit 12A. The first contact heating unit 131A includes a first contact heating surface 132A serving as a contact heating surface 132 configured to come into contact with the back surface P2 of the medium P and heat it. In addition, the second drying unit 10B includes a second contact heating unit 131B provided in a region of the transport path of the medium P that is opposed to the second airflow ejecting unit 12B. The second contact heating unit 131B includes a second contact heating surface 132B configured to come into contact with the back surface P2 of the medium P and heat it. The second contact heating unit 131B has a configuration similar to the first contact heating unit 131A. The contact heating surface 132 may be configured to include a rubber heater or the like, for example.

In this manner, the printing apparatus 1 according to the present embodiment includes: the roller 6 serving as the transport unit configured to transport the medium P in the transport direction A; the printing head 3 configured to discharge ink on the medium P transported by the roller 6 to perform printing; and the drying unit 10 configured to dry the medium P on which printing is performed by the printing head 3. The drying unit 10 is separated into the first drying unit 10A and the second drying unit 10B. The first drying unit 10A includes the first contact heating unit 131A, and the first airflow ejecting unit 12A disposed at a position that is opposed to the first contact heating unit 131A. The second drying unit 10B includes the second contact heating unit 131B provided downstream of the first contact heating unit 131A in the transport direction A, and also includes the second airflow ejecting unit 12B disposed at a position that is opposed to the second contact heating unit 131B.

The first contact heating unit 131A includes the first contact heating surface 132A that is opposed to the back surface P2 of the medium P after printing and comes into contact with the back surface P2. The second contact heating unit 131B includes the second contact heating surface 132B that is opposed to the back surface P2 of the medium P after printing and comes into contact with the back surface P2. The first airflow ejecting port 121A of the first airflow ejecting unit 12A is opposed to the first contact heating surface 132A. The second airflow ejecting port 121B of the second airflow ejecting unit 12B is opposed to the second contact heating surface 132B.

As illustrated in FIGS. 1 and 2, the rollers 6 disposed between the first drying unit 10A and the second drying unit 10B in the transport path of the medium P turn back the transport path of the medium P. In other expressions, the rollers 6 disposed between the first drying unit 10A and the second drying unit 10B constitute a folding portion 61 disposed downstream of the first contact heating unit 131A in the transport direction A and upstream of the second contact heating unit 131B in the transport direction A. The folding portion 61 turns back the medium P such that the back surface P2 coming into contact with the first contact heating surface 132A is brought into contact with the second contact heating surface 132B.

The transport path of the medium P is configured between the first contact heating surface 132A and the first airflow ejecting unit 12A and between the second contact heating surface 132B and the second airflow ejecting unit 12B, as illustrated in FIG. 2. Note that although detailed description will be made later, the printing apparatus 1 according to the present embodiment is configured so as to be able to adjust a first gap G1 that is a distance between the first contact heating surface 132A and the first airflow ejecting port 121A and a second gap G2 that is a distance between the second contact heating surface 132B and the second airflow ejecting port 121B. As described above, the drying unit 10 according to the present embodiment includes the contact heating unit 131 (the first contact heating unit 131A and the second contact heating unit 131B), and the airflow ejecting unit 12 (the first airflow ejecting unit 12A and the second airflow ejecting unit 12B) configured to eject an airflow from the airflow ejecting port 121 (the first airflow ejecting port 121A and the second airflow ejecting port 121B) disposed at a position that is opposed to the contact heating unit 131. In addition, the contact heating unit 131 includes the contact heating surface 132 (the first contact heating surface 132A and the second contact heating surface 132B) configured to come into contact with the back surface P2 that is a surface opposite from the printing surface P1. The airflow ejecting port 121 is opposed to the contact heating surface 132.

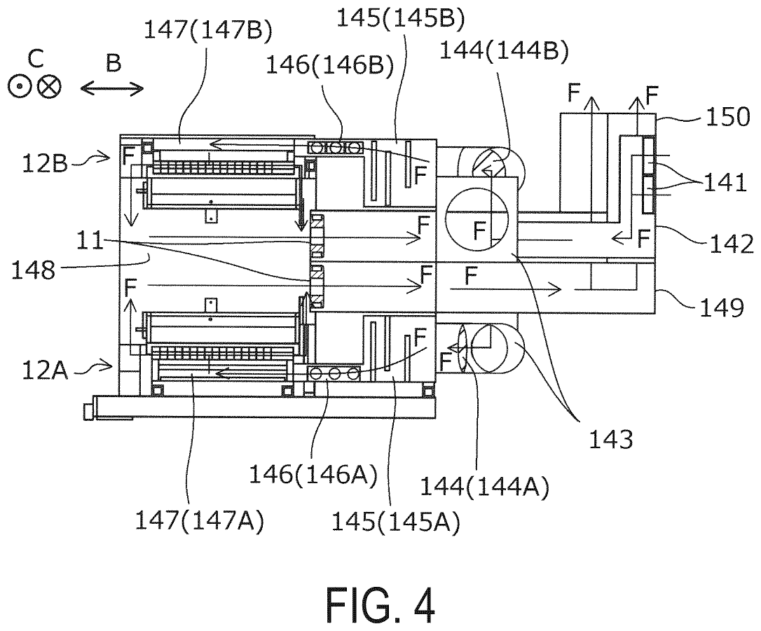

Next, the flow of an airflow at the drying unit 10 will be described with reference to FIGS. 4 to 6. The flow of an airflow is indicated by the arrow F in FIG. 4. The drying unit 10 includes a suction unit 142 provided with a suction fan 141 that is a DC fan. The suction unit 142 is coupled to a circulation mixture unit 143 provided with a valve 144 (a first valve 144A and a second valve 144B), and the airflow drawn from the suction fan 141 flows from the suction unit 142 to the circulation mixture unit 143 as indicated by the arrow F.

The circulation mixture unit 143 is coupled to a first pressure chamber 145A and a second pressure chamber 145B that are two pressure chamber 145, and the airflow flows from the circulation mixture unit 143 to the first pressure chamber 145A and the second pressure chamber 145B as indicated by the arrow F. The pressure chamber 145 is a unit used to cause the airflow to be uniformly hit against a heater unit 146 that will be described later. The first pressure chamber 145A is coupled to a first heater unit 146A serving as the heater unit 146, and the airflow flows from the first pressure chamber 145A to the first heater unit 146A as indicated by the arrow F. In addition, the second pressure chamber 145B is coupled to a second heater unit 146B serving as the heater unit 146, and the airflow flows from the second pressure chamber 145B to the second heater unit 146B as indicated by the arrow F. The heater unit 146 according to the present embodiment is configured to include a cartridge heater having a length of 1500 mm and configured to heat the airflow to a temperature of 75° C.

The first heater unit 146A is coupled to a first nozzle box 147A serving as a nozzle box 147 provided at the first airflow ejecting unit 12A, and the airflow flows from the first heater unit 146A to the first nozzle box 147A as indicated by the arrow F. The nozzle box 147 is a unit used to cause the heated airflow to blow to the medium P. In addition, the second heater unit 146B is coupled to a second nozzle box 147B serving as the nozzle box 147 provided at the second airflow ejecting unit 12B, and the airflow flows from the second heater unit 146B to the second nozzle box 147B as indicated by the arrow F.

The first nozzle box 147A includes a first airflow ejecting surface 120A including the first airflow ejecting port 121 serving as an airflow ejecting surface 120. As indicated by the arrow F, the airflow flows through the first airflow ejecting port 121 to a fan formation unit 148 including the fans 11. In addition, the second nozzle box 147B includes a second airflow ejecting surface 120B including the second airflow ejecting port 121B. As indicated by the arrow F, the airflow flows through the second airflow ejecting port 121B to the fan formation unit 148 including the fans 11. Here, the fan 11 is a DC fan, and is a component member used to emit the heated airflow from the inside of the drying unit 10.

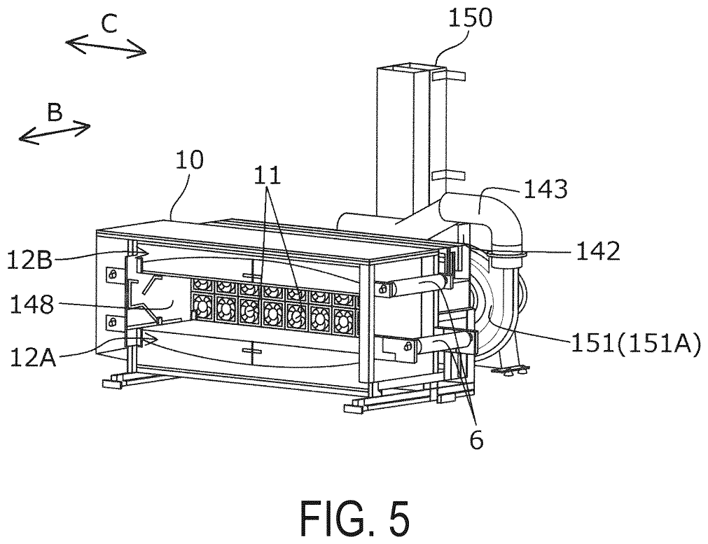

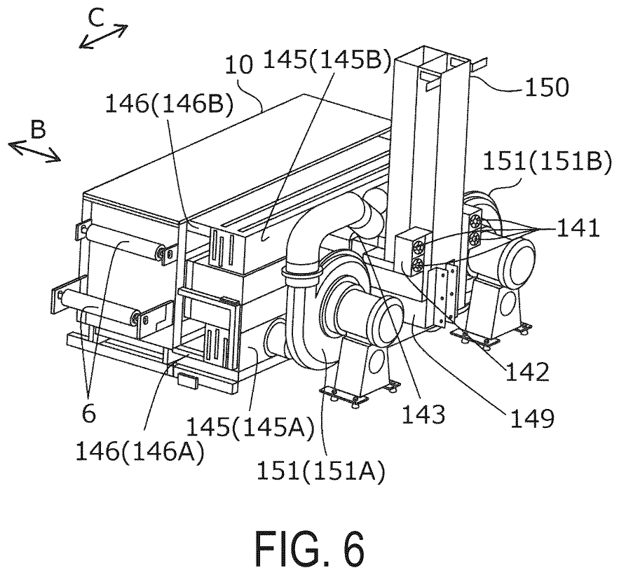

The fan formation unit 148 is coupled to an air outlet path 149 coupled to an air outlet duct 150. The airflow is delivered from the fan formation unit 148 through the air outlet path 149 to the air outlet duct 150 as indicated by the arrow F. That is, the airflow circulating within the drying unit 10 is emitted from the air outlet duct 150 to the outside of the printing apparatus 1. Here, the fan formation unit 148 is also coupled to the circulation mixture unit 143 through the air outlet path 149. The fan formation unit 148 collects the heated airflow to mix it with the outside air. The heated airflow is delivered to the pressure chamber 145 by an air blower 151. Note that, as illustrated in FIGS. 5 and 6, the air blower 151 (a first air blower 151A and a second air blower 151B) together with the suction fan 141 and the fans 11 facilitates flowing of the airflow within the drying unit 10.

With control by the control unit 7, the printing apparatus 1 according to the present embodiment is able to control an airflow. Below, the control of an airflow by the control unit 7 will be described. The control unit 7 is able to perform first control and second control. In the first control, the airflow ejecting unit 12 is controlled such that a reaching velocity is a first velocity. The reaching velocity is a velocity when an airflow ejected from the airflow ejecting unit 12 reaches the printing surface P1 of the medium P supported by the contact heating surface 132. In the second control, the airflow ejecting unit 12 is controlled such that the velocity at which the airflow reaches the printing surface P1 is slower than the first velocity. Specifically, while the printing apparatus 1 being in operation, the control unit 7 is able to perform the first control when a stopping period is less than a predetermined period, and perform the second control instead of the first control when the stopping period is equal to or more than the predetermined period. The stopping period is a period in which transporting the medium P by the roller 6 serving as the transport unit is at rest.

Thus, the printing apparatus 1 according to the present embodiment makes it possible to reduce the reaching velocity of the airflow to the printing surface P1 in a case where a stopping period is equal to or more than a predetermined period, this case being a case in which there is a possibility that the back surface P2 of the medium P and the contact heating surface 132 stick to each other or a frictional force occurring during transporting the medium P increases, which deteriorates the transport performance. Thus, the printing apparatus 1 according to the present embodiment makes it possible to suppress sticking of the back surface P2 of the medium P and the contact heating surface 132 to each other and suppress an increase in the frictional force.

Specifically, the control unit 7 is able to perform control or the like of an airflow in accordance with tables shown in table 1 to table 3 below. First, description will be made of control of an airflow in accordance with the table shown in table 1. At the time of controlling an airflow in accordance with the table shown in table 1, different types of control are performed for four cases, which include a case where the medium P is transported during intermittent transporting in performing a printing operation, a case where transporting of the medium P is at rest for a predetermined period of time or more in performing the printing operation, a case where the medium P is transported when the printing operation is not performed, and a case where transporting of the medium P is at rest for a predetermined period of time or more when the printing operation is not performed.

TABLE 1

| Whether or not | Transporting | | | | |
|---|---|---|---|---|---|
| printing | is performed | | | | |
| operation is | or not | Stopping | Air | Drying | |
| being performed | performed | period | velocity | aid | Purpose |
| Printing | Yes | 0 | Weak | Yes | Reduce |
| operation is | | | | | transporting |
| being | | | | | load |
| performed | No | Less | Strong | No | Give |
| | | than 1 | | | priority to |
| | | minute | | | drying |
| Operation | No | 1 minute | Weak | No | Prevent |
| other than | | or more | | | sticking |
| performing | Yes | 0 | Strong | No | Maintain |
| printing | | | | | temperature |
| operation | | | | | |

When the airflow is controlled in accordance with the table shown in table 1, the purpose of controlling the airflow when the medium P is being transported during the intermittent transporting in performing the printing operation is to reduce the transporting load occurring due to the airflow at a high air velocity being hit against the medium P to cause the medium P to be strongly pressed against the contact heating surface. At the time of this controlling, the air velocity that is a velocity at which the airflow reaches the printing surface P1 is set to a low air velocity that is slower than a high air velocity that is the first velocity. However, as the air velocity is set to the low air velocity, the drying performance of the medium P reduces, and hence, drying aid is performed. Specifically, the drying aid includes increasing a temperature of the contact heating surface 132, increasing a temperature of the heater unit 146 configured to heat the airflow, increasing a period of time in which the medium P stays within the drying unit 10, and the like.

The purpose of controlling the airflow when the medium P is at rest during intermittent transporting in performing the printing operation, that is, when ink is discharged from the printing head 3 on the printing surface P1 of the medium P is to give priority to drying the medium P. Note that, when the medium P is at rest during the intermittent transporting in performing the printing operation, the stopping period is equal to or less than one minute. In a case of this controlling, the air velocity that is a velocity at which the airflow reaches the printing surface P1 is set to the high air velocity that is a velocity in a case of the first velocity. In a case of this controlling, since the air velocity is set to the high air velocity, the drying aid is not performed.

The purpose of controlling the airflow when the printing operation is not being performed and the medium P is at rest, for example, during a maintenance operation is to prevent the medium P from sticking to the contact heating surface. In a case of this controlling, the air velocity that is a velocity at which the airflow reaches the printing surface P1 is set to the low air velocity that is slower than the high air velocity in a case of the first velocity. In a case of this controlling, since the printing operation is not being performed, the drying aid is not performed.

The purpose of controlling the airflow when the printing operation is not being performed and the medium P is transported, for example, when an operator winds the medium P backward is to maintain a temperature within the drying unit 10. When the air velocity reduces, the temperature within the drying unit 10 is more likely to reduce. Thus, in a case of this controlling, the air velocity that is a velocity at which the airflow reaches the printing surface P1 is set to the high air velocity that is a velocity in a case of the first velocity. In a case of this controlling, since the printing operation is not being performed, the drying aid is not performed.

Next, description will be made of control of an airflow in accordance with the table shown in table 2. At the time of controlling an airflow in accordance with the table shown in table 2, different types of control are performed for six cases in total. These include a case where the medium P is being transported during the intermittent transporting in performing a printing operation, a case where the medium P is at rest for a predetermined period of time or more in performing the printing operation, a case where the medium P is being transported when the printing operation is not performed, and a case where the medium P is at rest for a predetermined period of time or more when the printing operation is not performed. In addition, when transporting is at rest, different types of control are performed in accordance with types of the medium P.

TABLE 2

| Whether or not | Transporting is | | | | | |
|---|---|---|---|---|---|---|
| printing operation | performed or | Stopping | Type of | Air | Drying | |
| is being performed | not performed | period | medium | velocity | aid | Purpose |
| Printing operation | Yes | 0 | All | Weak | Yes | Reduce |
| is being performed | | | | | | transporting load |
| | No | Less than 1 | PE | Weak | Yes | Prevent sticking |
| | | minute | Other | Strong | No | Give priority |
| | | | than PE | | | to drying |
| Operation other | No | 1 minute | PE | Weak | No | Prevent sticking |
| than performing | | or more | Other | Strong | No | Maintain |
| printing operation | | | than PE | | | temperature |
| | Yes | 0 | All | Strong | No | Maintain |
| | | | | | | temperature |

When the airflow is controlled in accordance with the table shown in table 2, control is performed in a manner similar to that in the table shown in table 1 for the control when the medium P is being transported during the intermittent transporting in performing the printing operation and the control of an airflow when the printing operation is not being performed and the medium P is transported. On the other hand, as for the control when the medium P is at rest during the intermittent transporting in performing the printing operation and the control of the airflow when the printing operation is not being performed and the medium P is at rest, different types of control are performed depending on types of material used for the back surface P2 of the medium P to be used. Specifically, control differs from that in the table shown in table 1 only in a case where polyethylene (PE) is used for the back surface P2 of the medium P to be used. Polyethylene has a characteristic in which it is more likely to stick to the contact heating surface.

The purpose of controlling the airflow when polyethylene is used for the back surface P2 of the medium P to be used and the medium P is at rest during the intermittent transporting in performing the printing operation is to prevent sticking of the medium P. For example, when printing resumes after maintenance corresponding to an operation other than performing the printing operation, the air velocity is set to the low air velocity during an operation other than performing the printing operation when the medium P is at rest as described later. Thus, a temperature of the inside of the drying unit 10 may reduce. As the temperature within the drying unit 10 reduces, the drying efficiency deteriorates. In order to compensate for this, it is necessary to increase the drying period, that is, increase the stopping period. As the stopping period increases, the medium P is more likely to stick to the contact heating surface 132. Here, when the air velocity that is a velocity at which the airflow reaches the printing surface P1 after printing resumes is set to the high air velocity in a case of the first velocity, the airflow that is not sufficiently heated is caused to strongly blow against the medium P, which leads to a possibility that the medium P sticks to the contact heating surface 132, for example. This is control in which an air velocity for reducing such a possibility is used as the low air velocity. At the time of performing this control, the air velocity is set to the low air velocity, and hence, the drying aid is performed.

The purpose of controlling the airflow when polyethylene is used for the back surface P2 of the medium P to be used, the printing operation is not being performed, and the medium P is at rest is also to prevent the medium P from sticking. Specifically, the air velocity is set to the low air velocity. At the time of performing this control, the printing operation is not being performed, and hence, the drying aid is not performed.

Next, description will be made of control of an airflow in accordance with the table shown in table 3. At the time of controlling an airflow in accordance with the table shown in table 3, different types of control are performed for six cases in total, as with the control of the airflow in accordance with the table shown in table 2. These include a case where the medium P is being transported during the intermittent transporting in performing a printing operation, a case where the medium P is at rest for a predetermined period of time or more in performing the printing operation, a case where the medium P is being transported when the printing operation is not performed, and a case where the medium P is at rest for a predetermined period of time or more when the printing operation is not performed. In addition, when transporting is at rest, different types of control are performed in accordance with types of the medium P. The control of the airflow in accordance with the table shown in table 3 differs from the control of the airflow in accordance with the table shown in table 2 only in the control of the airflow when polyethylene is used for the back surface P2 of the medium P to be used, and the medium P is at rest during the intermittent transporting in performing the printing operation.

TABLE 3

| Whether or not | Transporting is | | | | | |
|---|---|---|---|---|---|---|
| printing operation | performed or | Stopping | Type of | Air | Drying | |
| is being performed | not performed | period | medium | velocity | aid | Purpose |
| Printing operation | Yes | 0 | All | Weak | Yes | Reduce |
| is being performed | | | | | | transporting load |
| | No | Less than 1 | PE | Weak → | Yes | Prevent sticking |
| | | minute | | middle → | (when | |
| | | | | strong | weak) | |
| | | | Other | Strong | No | Give priority |
| | | | than PE | | | to drying |
| Operation other | No | 1 minute | PE | Weak | No | Prevent sticking |
| than performing | | or more | Other | Strong | No | Maintain |
| printing operation | | | than PE | | | temperature |
| | Yes | 0 | All | Strong | No | Maintain |
| | | | | | | temperature |

In a case of the control of the airflow when polyethylene is used for the back surface P2 of the medium P to be used, and the medium P is at rest during the intermittent transporting in performing the printing operation, the air velocity is changed sequentially into the low air velocity, the middle air velocity, and the high air velocity. Note that the period of time for which the air velocity is set to the low air velocity is set to a period in which a temperature within the drying unit 10 returns, for example. In addition, the drying aid is performed only when the air velocity is the low air velocity. By performing such control, it is also possible to prevent the medium P from sticking.

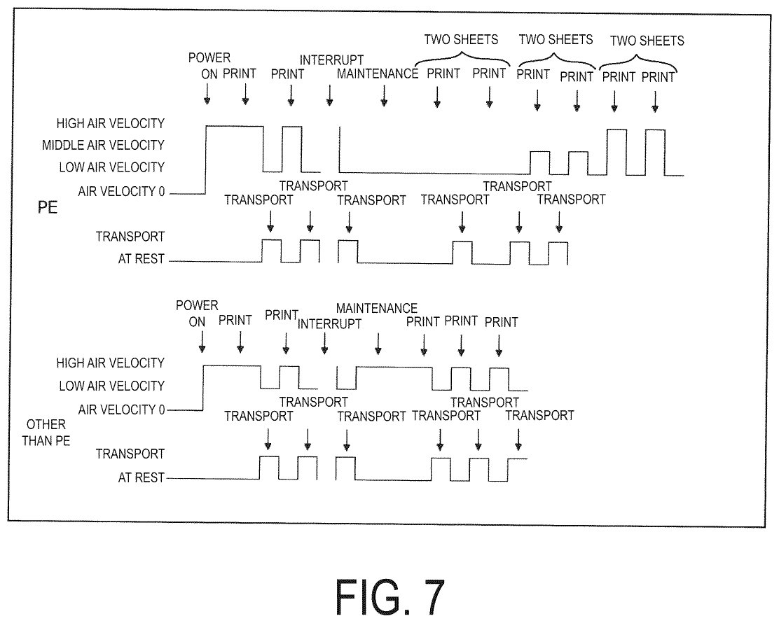

Here, control of the airflow in accordance with the table shown in table 3 will be described more in detail with reference to FIG. 7. FIG. 7 illustrates the strength of air velocities that correspond to states where the medium P is transported in a case where polyethylene is used for the back surface P2 of the medium P to be used and in a case where polyethylene is not used.

When polyethylene is used for the back surface P2 of the medium P to be used, power supply is turned on, the air velocity is set to the high air velocity, and printing is performed in this state. At the time of performing transporting during the intermittent transporting, the air velocity is set to the low air velocity, and when transporting is at rest during the intermittent transporting, which corresponds to during the printing operation being performed, the air velocity is set to the high air velocity. This corresponds to control of the air flow when polyethylene is used for the back surface P2 of the medium P to be used in table 3, and also when the medium P is being transported as well as is at rest during the intermittent transporting in performing the printing operation in a period before printing is suspended.

After the printing operation is suspended and transporting of the medium P is at rest, a maintenance operation is performed. Transporting is at rest when the maintenance operation is being performed. This case corresponds to the medium P being at rest during the intermittent transporting in an operation other than the printing operation being performed in table 3, and the air velocity is set to the low air velocity. When printing resumes after the maintenance operation, the printing operation is performed while sequentially changing the air velocity into the low air velocity, the middle air velocity, and the high air velocity during transporting of the medium P being at rest. This case corresponds to the medium P being at rest during the intermittent transporting when the printing operation is being performed in table 3. Note that, in the example in FIG. 7, the air velocity is changed sequentially into the low air velocity, the middle air velocity, and the high air velocity for each printing of two cycles corresponding to printing of two sheets of labels each serving as one example of the medium P. However, the configuration is not limited to this example. In addition, when polyethylene is not used for the back surface P2 of the medium P to be used and printing resumes after the maintenance operation, printing is performed by setting the air velocity to the high air velocity from the beginning during transporting of the medium P being at rest. Note that one sheet of label is a unit corresponding to a plurality of labels on which printing is performed by the printing head 3 in a region of the medium P supported by the platen 4 during one stop of the corresponding intermittent transporting in performing the printing operation.

In this manner, the control unit 7 of the printing apparatus 1 according to the present embodiment is configured to determine, according to a material of the back surface P2, whether to perform the first control in which the air velocity is set to the high air velocity or the second control in which the air velocity is set to the middle air velocity or the low air velocity when the stopping period corresponding to a case where intermittent transporting is at rest is equal to or more than a predetermined period. Depending on a material of the back surface P2 of the medium P, it is more likely that the back surface P2 of the medium P and the contact heating surface 132 stick to each other or a frictional force occurring during transporting the medium P increases, which deteriorates the transport performance. However, the printing apparatus 1 according to the present embodiment is configured to determine, according to a material of the back surface P2 of the material P, whether to perform the first control or the second control when the stopping period is equal to or more than the predetermined period. Thus, it is possible to suppress sticking of the back surface P2 of the medium P and the contact heating surface 132 to each other and suppress an increase in the frictional force according to the material of the back surface P2 of the medium P.

Specifically, the control unit 7 is configured to perform the second control when the back surface P2 includes polyethylene as a material. When polyethylene is included in the material of the back surface P2 of the medium P, in particular, included in a contact surface of the back surface P2 with the contact heating surface 132, it is more likely that the back surface P2 of the medium P and the contact heating surface 132 stick to each other or a frictional force occurring during transporting the medium P increases, which deteriorates the transport performance. However, by employing a configuration in which the second control is performed when polyethylene is included in the material of the back surface P2, it is possible to suppress sticking of the back surface P2 of the medium P and the contact heating surface 132 to each other and suppress an increase in the frictional force even when polyethylene is included in the material of the back surface P2 of the medium P.

In addition, as illustrated in FIG. 7, the control unit 7 is configured, as the second control, to control the airflow ejecting unit 12 such that the reaching velocity of the airflow to the printing surface P1 is the low air velocity that is a second velocity slower than the high air velocity that is the first velocity, and also to control the airflow ejecting unit 12 such that the reaching velocity of the airflow to the printing surface P1 is the middle air velocity that is a third velocity faster than the low air velocity that is the second velocity and slower than the high air velocity that is the first velocity. Thus, the printing apparatus 1 according to the present embodiment is able to change the reaching velocity of the airflow to the printing surface P1 at three stages, and is able to favorably suppress sticking of the back surface P2 of the medium P and the contact heating surface 132 to each other and suppress an increase in the frictional force. Note that the printing apparatus 1 according to the present embodiment is configured to change the reaching velocity of the airflow to the printing surface P1 at three stages. However, it is possible to employ a configuration in which the reaching velocity of the airflow to the printing surface P1 can be changed at four or more stages.

In addition, as illustrated in FIG. 7, the control unit 7 is configured, as the second control, to control the airflow ejecting unit 12 to achieve the low air velocity that is the second velocity and then control the airflow ejecting unit 12 to achieve the middle air velocity that is the third velocity, and as the first control, to further control the airflow ejecting unit to achieve the high air velocity that is the first velocity. By performing control in this manner, it is possible to particularly favorably suppress sticking of the back surface P2 of the medium P and the contact heating surface 132 to each other and suppress an increase in the frictional force.

In the printing apparatus 1 according to the present embodiment is configured such that the roller 6 serving as the transport unit intermittently transports the medium P during performing printing to the medium P by the printing head 3, and the printing head 3 discharges ink to the medium P when transporting is at rest during the intermittent transporting, and does not discharge ink to the medium P when transporting is performed during the intermittent transporting. In addition, the control unit 7 is configured to control the airflow ejecting unit 12 such that the reaching velocity of the airflow to the printing surface P1 is the low air velocity that is slower than the high air velocity that is the first velocity when the medium P is transported during the intermittent transporting. When the airflow at the time of transporting the medium P during the intermittent transporting is strong and the medium P is pressed against the contact heating surface 132, a frictional force is more likely to increase. However, it is possible to suppress such an increase in the frictional force.

In addition, as described above, the printing apparatus 1 according to the present embodiment is able to perform drying aid. In other expressions, the control unit 7 is configured to at least one of: increase a temperature of the contact heating surface 132 during performing the second control to be higher than a temperature during performing the first control; increasing a temperature of the airflow ejected from the airflow ejecting port 121; and increasing a period of time in which the medium P stays within the drying unit 10. As the reaching velocity of the airflow to the printing surface P1 is reduced, the drying efficiency reduces as compared with the first control being performed. However, the printing apparatus 1 according to the present embodiment makes it possible to achieve drying aid for this reduction in the drying efficiency, by selecting at least one of: increasing a temperature of the contact heating surface 132; increasing a temperature of the airflow ejected from the airflow ejecting port 121; and increasing a period of time in which the medium P stays within the drying unit 10.

The printing apparatus 1 according to the present embodiment is configured such that, with the control by the control unit 7, driving a plurality of fans such as the suction fan 141 is controlled to control the air volume of the airflow ejecting unit 12, thereby controlling the reaching velocity of the airflow to the printing surface P1. By employing such a configuration, it is possible to favorably control the reaching velocity of the airflow to the printing surface P1 without increasing the number of component members.

Furthermore, in the printing apparatus 1 according to the present embodiment, the airflow ejecting unit 12 includes: the suction fan 141 configured to generate the airflow; and the circulation mixture unit 143 serving as the air guiding section configured to couple the suction fan 141 and the airflow ejecting port; and the valve 144 provided at the circulation mixture unit 143 and configured to control a degree of closing or opening, and the control unit 7 is configured to control the degree of closing or opening of the valve 144 to control the reaching velocity of the airflow to the printing surface P1. Thus, by controlling the degree of closing or opening of the valve 144, the printing apparatus 1 according to the present embodiment is able to favorably control the reaching velocity of the airflow to the printing surface P1.

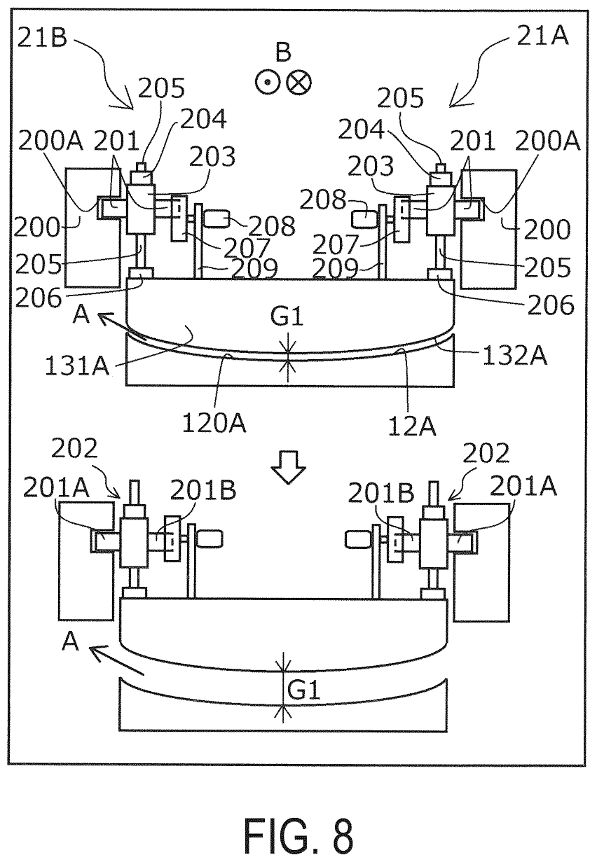

In addition, in the printing apparatus 1 according to the present embodiment, the airflow ejecting unit 12 is configured to change the distance between the contact heating surface 132 and the airflow ejecting port 121. The control unit 7 is configured to control a distance changing unit 21 illustrated in FIG. 2 to change the first gap G1 and the second gap G2 representing the distance, thereby controlling the reaching velocity of the airflow to the printing surface P1. Thus, by changing the distance between the contact heating surface 132 and the airflow ejecting port 121, the printing apparatus 1 according to the present embodiment is able to favorably control the reaching velocity of the airflow to the printing surface P1. Below, the configuration thereof will be described with reference to FIGS. 8 to 10.

The printing apparatus 1 according to the present embodiment includes, as the distance changing unit 21, a distance changing unit 21A, a distance changing unit 21B, a distance changing unit 21C, and a distance changing unit 21D, as illustrated in FIG. 2. As illustrated in FIG. 8, the distance changing unit 21 includes: a cam follower 201; a frame 200 engaged with the cam follower 201 and including a movement path 200A for the cam follower 201; and an attachment tool 202 to which the cam follower 201 (cam follower 201A) is attached, the attachment tool being attached to the first contact heating unit 131.

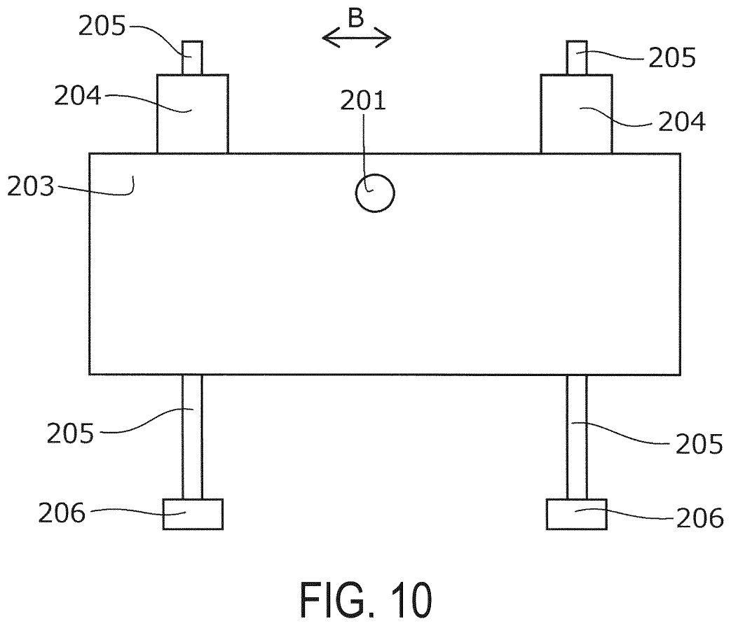

As illustrated in FIGS. 8 and 10, the attachment tool 202 includes a motor 208, a motor fixing portion 209, a cam mechanism comprised of the cam follower 201 (cam follower 201B) and a cam 207, a movement section 203 at which the cam follower 201 is provided, a movement shaft 205 of the movement section 203, a linear bush 204 attached to the movement shaft 205, and a holder 206 provided at the first contact heating unit 131A and configured to fix the movement shaft 205.

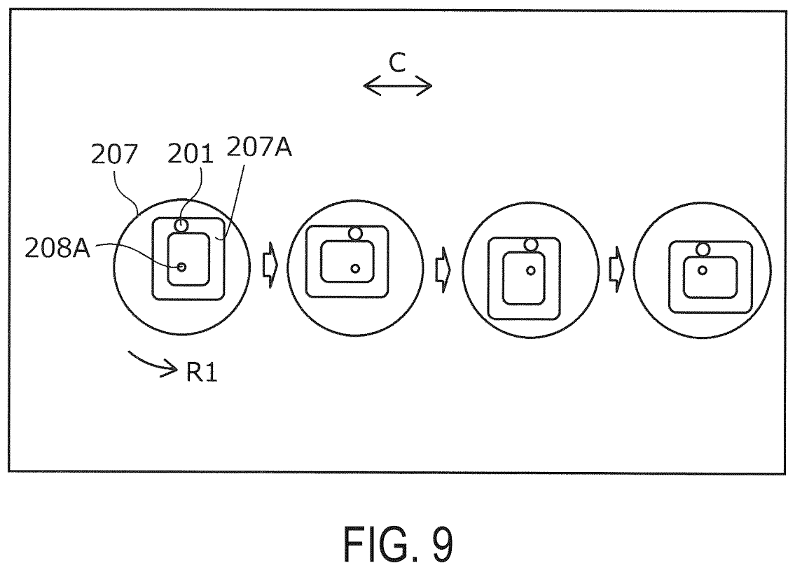

The printing apparatus 1 according to the present embodiment is configured such that the first gap G1 can be adjusted by driving the motor 208, causing the cam 207 to rotate in a rotational direction R1 with a motor shaft 208A of the motor 208 being the reference as illustrated in FIG. 9 to change the position of the cam mechanism, and changing the vertical position of the first contact heating unit 131A relative to the frame 200. As illustrated in FIG. 9, a rectangular movement path 207A for the cam follower 201 is provided at the cam 207 such that the center position thereof is shifted from the motor shaft 208A. By driving the motor 208, it is possible to change the position of the movement path 207A relative to the cam follower 201. This changes the vertical positions of the motor shaft 208A, the motor fixing portion 209 at which the motor 208 is fixed, and the first contact heating unit 131 at which the motor fixing portion 209 is fixed.

Note that the printing apparatus 1 according to the present embodiment also includes the distance changing unit 21C and the distance changing unit 21D having the configuration similar to the distance changing unit 21A and the distance changing unit 21B, which makes it possible to adjust the second gap G2. With such a configuration, the printing apparatus 1 according to the present embodiment is able to easily adjust the first gap G1 and the second gap G2.

The present disclosure is not limited to the embodiment described above, and can be realized in various configurations without departing from the spirit of the present disclosure. For example, in order to solve the problem described above in whole or in part, or in order to achieve the effects described above in whole or in part, the technical characteristics in the embodiment that corresponds to the technical characteristics in each mode described in the outline of the disclosure can be replaced or combined as necessary. Furthermore, when the technical characteristics are not described as being essential in the present specification, the technical characteristics can be deleted as appropriate.

What is claimed is:

1. A printing apparatus comprising:
a transport unit configured to transport a medium in a transport direction;
a printing unit configured to discharge a liquid to the medium transported by the transport unit to perform printing;
a drying unit configured to dry the medium having a printing surface on which printing is performed by the printing unit; and
a control unit, wherein
the drying unit includes a contact heating unit and an airflow ejecting unit disposed at a position that is opposed to the contact heating unit, the airflow ejecting unit being configured to eject an airflow from an airflow ejecting port,
the contact heating unit includes a contact heating surface configured to come into contact with a back surface that is a surface opposite from the printing surface,
the airflow ejecting port is opposed to the contact heating surface,
the control unit is configured to perform first control and second control,
the first control is control in which the airflow ejecting unit is controlled such that a reaching velocity is a first velocity, the reaching velocity being a velocity when an airflow ejected from the airflow ejecting unit reaches the printing surface of the medium supported by the contact heating surface,
the second control is control in which the airflow ejecting unit is controlled such that the reaching velocity is slower than the first velocity, and
while the printing apparatus is in operation, the control unit is configured to perform the first control when a stopping period is less than a predetermined period, and perform the second control instead of the first control when the stopping period is equal to or more than the predetermined period, the stopping period being a period in which transport of the medium by the transport unit is at rest.

2. The printing apparatus according to claim 1, wherein
the control unit is configured to determine, according to a material of the back surface, whether to perform the first control or the second control when the stopping period is equal to or more than the predetermined period.

3. The printing apparatus according to claim 2, wherein
the control unit is configured to perform the second control when the back surface includes polyethylene as a material.

4. The printing apparatus according to claim 1, wherein
the control unit is configured, as the second control, to control the airflow ejecting unit such that the reaching velocity is a second velocity slower than the first velocity and also control the airflow ejecting unit such that the reaching velocity is a third velocity faster than the second velocity and slower than the first velocity.

5. The printing apparatus according to claim 4, wherein
the control unit is configured, as the second control, to control the airflow ejecting unit to achieve the second velocity and then control the airflow ejecting unit to achieve the third velocity, and as the first control, to further control the airflow ejecting unit to achieve the first velocity.

6. The printing apparatus according to claim 1, wherein
the transport unit intermittently transports the medium while printing is performed on the medium by the printing unit,
the printing unit discharges the liquid to the medium when transporting is at rest during the intermittent transporting, and does not discharge the liquid to the medium when transporting is performed during the intermittent transporting, and
the control unit is configured to control the airflow ejecting unit such that the reaching velocity is slower than the first velocity when the medium is transported during the intermittent transporting.

7. The printing apparatus according to claim 1, wherein
the control unit is configured to control an air volume of the airflow ejecting unit to control the reaching velocity.

8. The printing apparatus according to claim 1, wherein
the airflow ejecting unit includes:
a fan configured to generate the airflow; and
an air guiding section configured to couple the fan and the airflow ejecting port; and
a valve provided at the air guiding section and configured to control a degree of closing or opening, and
the control unit is configured to control the degree of closing or opening of the valve to control the reaching velocity.

9. The printing apparatus according to claim 1, wherein
the airflow ejecting unit includes a distance changing unit configured to change a distance between the contact heating surface and the airflow ejecting port, and
the control unit is configured to control the distance changing unit to change the distance, thereby controlling the reaching velocity.

10. The printing apparatus according to claim 1, wherein
the control unit is configured to select at least one of: causing a temperature of the contact heating surface during the second control to be higher than a temperature during the first control; increasing a temperature of the airflow ejected from the airflow ejecting port; and increasing a period of time in which the medium stays within the drying unit.
